(19) United States
(12) Patent Application Publication
(10) Pub. No.: US 2011/0027768 A1
(43) Pub. Date: Feb. 3, 2011

(54) APPARATUS AND METHODS FOR RESOLVING CONFLICT

(75) Inventors: George A. Vraney, Jackson, TN (US); Jennifer A. Vraney, San Rafael, CA (US)

Correspondence Address: David B. Tingey, 1800 Eagle Gate Tower, 60 East South Temple, Salt Lake City, UT, 84145, US

(73) Assignee: Vraney, Inc.

(21) Appl. No.: 12/693,156

(22) Filed: Jan. 25, 2010

Related U.S. Application Data
(60) Provisional application No. 61/147,410, filed on Jan. 26, 2009.

(51) Int. Cl. G09B 3/00

(52) U.S. Cl. 434/322

(57) ABSTRACT

Apparatus and methods for resolving a decision conflict without the assistance of moderator are described herein. A representative method comprises providing a party to the decision conflict with a token that represents the first option to resolve the next decision conflict. When two parties are faced with a decision having only one reasonable outcome and the parties want different outcomes, the party with the token can either make the decision and pass the token to the other party, or the party with the token can retain the token and allow the other party to make the decision. In some cases, there is no limit to the number of times the token can be passed each day or how long a party can retain the token. In some cases, the methods and apparatus are modified to allow more than two parties to resolve a decision conflict without moderator intervention.

### CROSS-REFERENCE TO RELATED APPLICATIONS

This application claims the benefit of U.S. Provisional Application No. 61/147,410, filed Jan. 26, 2009, entitled “Apparatus and Methods for Resolving Conflict,” the entire disclosure of which is hereby incorporated by reference.

### BACKGROUND OF THE INVENTION

1. Field of the Invention

The present invention relates to apparatus and methods for resolving conflicts between two or more parties. In particular, the present invention relates to apparatus and methods for resolving a conflict over a decision by providing at least one party to the conflict with a token that represents the opportunity to lead in resolving the conflict.

2. Background and Related Art

Regularly, two or more children are faced with a decision that affects some or all of the children involved. In such situations, the desires of one child are often at odds with the desires of another child—especially where the decision to be made has only one reasonable outcome. By way of example, when presented with the decision of which movie to watch, two children may each desire to watch a different movie. Accordingly, where the children can only watch one movie, the decision by one child to watch a particular movie prevents the other child from watching the movie of that child's choice.

Currently, conflicts between children's desires are resolved in a wide variety of ways. In one example, a mediator, such as a parent, guardian, teacher, friend, or the like, mediates conflicts by making the decision for the children or by choosing which child gets to make the decision. In another example, the more dominant child forces its decision on the less dominant child. In still another example, the children are forced to compromise and make another decision that does not allow either child to have the decision made as they would like it.

While many conventional methods for resolving conflicts between children's desires have proven to be effective, such methods may still have shortcomings. For example, where a mediator mediates the decision making process, one or more children may feel the final decision is unfair. Accordingly, conflict resolution by a mediator may lead to additional conflict. In another example, by making the decision, the mediator may remove the opportunity for the children to learn how to resolve conflict in an acceptable manner. In yet another example, many methods for resolving conflict between children's desires do not teach the children how to prioritize decisions and to pick their battles. Instead, some methods for resolving conflict may actually teach children to fight in order to have their way.

Thus, while techniques currently exist that are used to resolve conflicts over children's divergent desires, challenges still exist, including those previously mentioned. Accordingly, it would be an improvement in the art to augment or even replace current techniques with other techniques.

### SUMMARY OF THE INVENTION

The present invention relates to apparatus and methods for resolving conflicts between two or more parties. In particular, the present invention relates to apparatus and methods for resolving a conflict over a decision (or a decision conflict) by providing a party to the conflict with a token that represents a first option to resolve the decision conflict. If the party with the first option, or first party, chooses to have its way, the first party passes the token to a second party to signify that the second party has the first option to resolve the next decision conflict. If, however, the first party chooses not to have its way and to keep the token, the first party reserves the right to have the first option to resolve the next conflict. By retaining the token, the first party further signifies its willingness to acquiesce to the decision made by the second party in the present conflict.

The token can comprise any suitable object that represents an option for the party who holds the token to resolve a decision conflict before another party. In some implementations, however, the token comprises an object that is easily portable. One non-limiting example of such a token is a coin.

In some implementations, a party to a decision conflict consists of an individual, such as a child. Nevertheless, in other instances, a party to a decision conflict comprises at least two individuals who are willing to resolve decision conflicts together. In this regard, a non-limiting example of a party comprising more than one individual is a team, such as a children's sports team.

In some cases, the described apparatus and methods are modified to allow one or more predetermined criteria to be set before the parties use the token to resolve a decision conflict. In such cases, the predetermined criteria may include any suitable number and type of criteria that allow the parties to modify the methods and still use the token to resolve decision conflicts. Non-limiting examples of suitable criteria include statements regarding: what conflict decisions can be resolved through the use of the token; when any of the parties; forfeits its chance to use the token and must pass the token to another; when a party's behavior associated with the use of the token merits a reward or other positive reinforcement; how the methods can be modified to fit a given desire; and any other suitable criteria that modify or further delineate the methods for using the token.

In some implementations, the described apparatus and methods are modified to allow more than two parties to resolve a decision conflict without intervention from a moderator. In such implementations, the participating parties may resolve a decision conflict in any manner that allows at least one of the parties to use the token to symbolize a right to an option to resolve the decision conflict before another party.

In one non-limiting example, a suitable method for resolving a decision conflict between more than two parties involves the use of a plurality of tokens having different hierarchical rankings. In this example, all but one of the parties receives a token that has a hierarchical ranking indicating that the party possessing that token has an option to resolve a decision conflict before at least one other party. Thus, in this example, one of the participating parties either receives a token having the lowest hierarchical ranking or receives no token at all.

When the parties in preceding example are faced with a decision conflict, the party with the highest ranking token, or the first party, is given the first opportunity to resolve the conflict. In other words, the first party is allowed to either choose to make the decision and pass the highest ranking token to another party (such as to the party with the second highest ranking token), or the first party can choose to keep the highest ranking token and allow the party with the second highest ranking token, or the second party, to exercise its option to make the decision that will resolve the current conflict.

Continuing with the example, if the first party chooses to keep the highest ranking token and allow the second party to resolve the conflict, and if the second party chooses to make the decision that resolves the current conflict, then the second party will pass the second highest ranking token onto another party (such as a third party having the third highest ranking token, or if no such token exists, no token at all). In contrast, if the second party chooses to keep the second highest ranking token for a future conflict, the second party passes the option to resolve the current conflict onto the third party.

With regards to the aforementioned example, until a party makes a decision that resolves the current conflict, each party with a token can choose, in turn, to retain its token and allow the next lower ranking party to have an option to resolve the current conflict. If the option to resolve the current decision conflict is passed all the way down to the party with the lowest ranking token or with no token at all, then that party can make the decision to resolve the conflict or can pass the decision to another, such as the party currently holding the highest ranking token, a moderator, etc.

In some implementations, each time a party chooses to make the decision that resolves a conflict and to pass its token to the party with the next lower ranking token, each party having a token with a lower hierarchical ranking that the first token being passed will pass its token to the next party having the sequentially lower ranking token, or if applicable, to the party having no token.

The method from the aforementioned non-limiting example can be repeated when the parties are faced with the next decision conflict. Indeed, in some implementations, when the parties are confronted with the next conflict, the party that currently has the highest ranking token is given the first opportunity to make the decision or to pass the option onto the party that currently has the second highest ranking token.

While the described apparatus and methods have proven to be particularly useful for resolving conflicts between children, those skilled in the art can appreciate that the described apparatus and methods can be implemented with people of any suitable age group, including non-children, such as teenagers, adolescents, adults and/or another age group. Moreover, the skilled artisan will understand that the apparatus and methods can be used in association with people from different age groups, such as a child and a teenager, a parent and a child, two or more siblings, multiple peers, business associates, and the like.

These and other features and advantages of the present invention will be set forth or will become more fully apparent in the description that follows and in the appended claims. The features and advantages may be realized and obtained by means of the instruments and combinations particularly pointed out in the appended claim set. Furthermore, the features and advantages of the invention may be learned by the practice of the invention or will be obvious from the description as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A illustrates a plan view of a first side of a representative embodiment of a token;

FIG. 1B illustrates a plan view of a second side of the token from FIG. 1A;

FIG. 2 illustrates a flow chart of a representative embodiment of a method for resolving decision conflicts between two parties; and

FIG. 3 illustrates a flow chart of a representative embodiment of a method for resolving decision conflicts between more than two parties.

### DETAILED DESCRIPTION OF THE INVENTION

The present invention relates to apparatus and methods for resolving conflicts between two or more parties. In particular, the present invention relates to apparatus and methods for resolving a conflict over a decision (a “decision conflict”) by providing a party to the conflict with a token that represents the first opportunity to lead in resolving a decision conflict. When two parties are faced with a decision having only one reasonable outcome and the parties each want a different outcome, the party with the token can either make the decision and pass the token to the other party, or retain the token and allow the second party to make the decision that resolves the current conflict.

The described methods can be used to resolve virtually any type of decision conflict in which two or more parties want different outcomes to a decision and only one outcome is possible, reasonable, and/or appropriate. By way of non-limiting example, the described methods can be used to resolve conflicts over which activity to do, when to do the activity, who will participate in the activity, how the activity will be done, where the activity will be done, etc.

As used herein, the term “party” or “parties” may refer to one or more individuals who are participating in the described methods and who choose to be bound by the same decisions regarding a decision conflict. Indeed, in some embodiments, a party consists of a single individual, such as a child. In other embodiments, however, a party comprises two or more people. Some non-limiting examples of parties that comprise more than one individual include a team (e.g., a little-league team), a group, a family, or any other suitable collection of people that desire a similar resolution to a decision conflict.

While the described methods have proven to be effective at helping children resolve decision conflicts, the methods can be used with virtually any party who is capable of following the described methods. By way of non-limiting example, the described methods can be used by children, teenagers, adolescents, adults, senior citizens, and/or any other age group. In another non-limiting example, the parties can be selected from any suitable combination of age groups. Indeed, in some non-limiting implementations, the described apparatus and methods are used to resolve decision conflicts between one or more children and adults, teens and children, teens and adults, etc. For instance, where a child has a conflict with its parent, the two parties can use the token to resolve the conflict.

The token can comprise any object that signifies that the party possessing the token (the “token holder”) has the option to resolve a decision conflict before another party. In some presently preferred embodiments, however, the token comprises an object that is easily portable and that fits within a pocket. Some non-limiting examples of a suitable token include a coin, a figurine, a piece of material, a rock, an elongated shaft, or any other object that can be used to indicate an option to resolve a decision conflict before another party. In some presently preferred embodiments, however, the token comprises a coin.

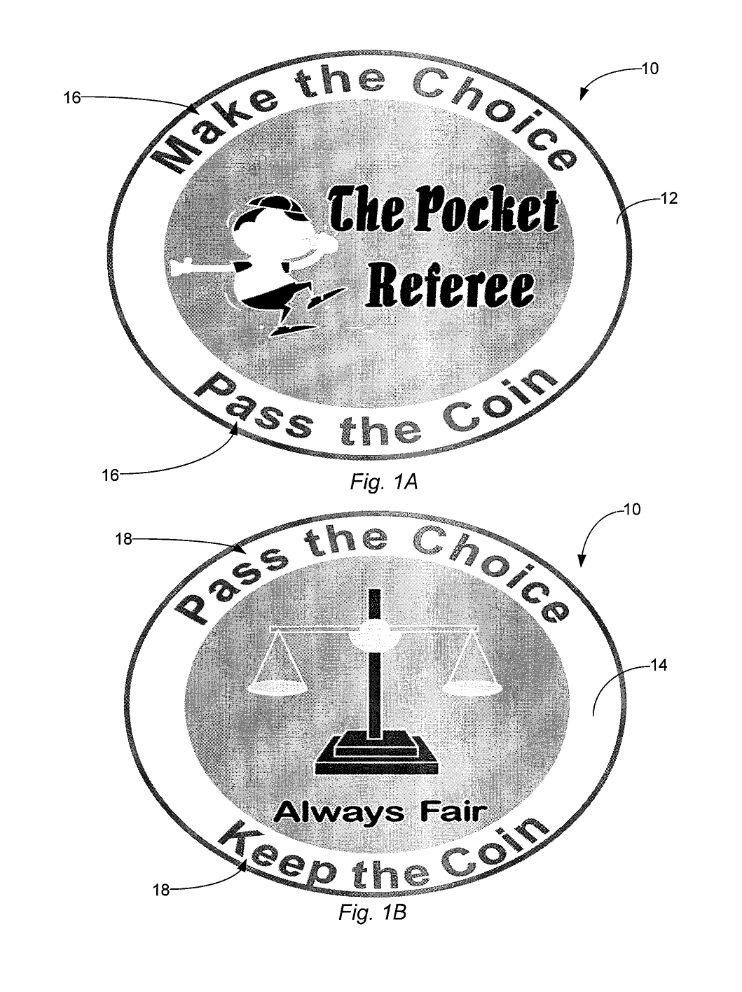

The token can comprise any suitable characteristic that allows it to function as intended. In one non-limiting example, FIGS. 1A and 1B show that where the token comprises a coin 10, the coin 10 comprises a first side 12 and a second side 14. In another non-limiting example, the token comprises instructions regarding its use. By way of non-limiting illustration, FIG. 1A shows an embodiment in which the first side 12 of the coin 10 includes a first set of instructions 16 that remind the current token holder that if the token holder makes the decision to resolve a conflict decision, then the token holder must pass the coin 10 to another party (such as a second party). Similarly, FIG. 1B shows an embodiment in which the second side 14 of the coin 10 contains a second set of instructions 18 that remind the token holder that if the token holder decides to allow another party (such as the second party) to resolve the current conflict, the token holder can keep the coin 10 for use with the next decision conflict.

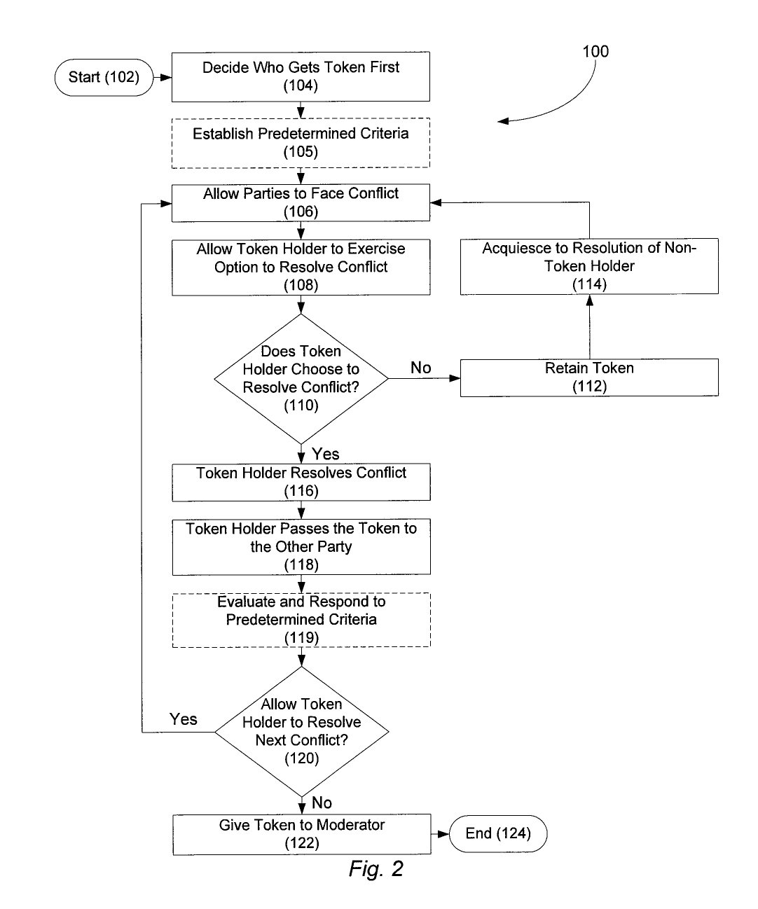

While the described methods can be implemented with two parties in any suitable manner, FIG. 2 illustrates a flow chart of a representative embodiment of a method 100 for using the token to resolve decision conflicts between two parties. It should be noted, however, that the method 100 shown in FIG. 2 can be modified in any suitable manner. For instance, one or more elements can be added to, removed from, or rearranged within the method 100 in any suitable manner that allows the parties to use the token when resolving a conflict.

With reference to FIG. 2, that figure shows that after beginning at 102, the illustrated method 100 continues at box 104 by deciding which of the two parties gets the token first. This decision may be made in any suitable manner. In one non-limiting example where the token comprises a coin, the parties flip the coin to determine who receives the coin first. In another non-limiting example, a moderator, such as a parent, determines who gets the token first. In still another example, a moderator hides the token in one hand and allows the parties to guess which hand is holding the token.

Once one of the parties has the token, box 105 of FIG. 2 shows the method 100 optionally includes establishing at least one predetermined criterion regarding how the method can be implemented. While establishing at least one predetermined criterion may be useful for many reasons, in some non-limiting embodiments, the predetermined criteria improve the pedagogical effect of, provide additional fun to, or otherwise improve the described methods.

Where the method includes establishing predetermined criteria, these criteria can be established at any suitable point during the method 100. In some presently preferred embodiments, however, FIG. 2 shows the criteria are determined before the token holder is allowed to exercise an option to resolve a decision conflict (as shown at 108 and discussed hereinafter).

Where the method 100 includes establishing one or more predetermined criteria, the criteria may include any suitable statements relating to ways to modify or further delineate the described methods. In one non-limiting embodiment, the predetermined criteria include one or more statements as to what type of conflict decisions can be resolved through the use of the token. In this embodiment, the parties, a moderator, and/or any other suitable person or entity, can make any suitable decision as to what type of decision conflicts can or cannot be resolved through the use of the token and the described methods. In one-non-limiting example, the parties, a moderator, or another decide that the parties cannot use the token to get out of doing chores, to punish another party, to embarrass another party, to spend more than a certain amount of money, to override a moderator (such as a parent or guardian), etc.

In another non-limiting embodiment, the predetermined criteria include any suitable statements that indicate the circumstances under which the current token holder forfeits its chance to use the token and needs to pass the token to another party (such as the second party, the moderator, etc.). Some non-limiting examples of such criteria include statements that the current token holder should pass the token to another (such as the second party, a moderator, etc.) if the token holder breaks a rule (e.g., by lying, hitting someone, throwing a tantrum, etc.), the token holder refuses to use the token for an extended period of time, the token holder loses the token, either party is impolite, etc.

In yet another non-limiting embodiment, the predetermined criteria include statements that indicate the conditions under which a party will merit a reward or other positive reinforcement for that party's actions regarding the use of the token. Some non-limiting examples of such statements include statements that a party will receive a reward (e.g., a treat, a point, etc.) when that party makes a decision that benefits another, when that party passes the token in certain time period, when that party makes the decision desired by a moderator, when that party exhibits sportsmanlike behavior, etc.

In a final non-limiting embodiment, the predetermined criteria include additional guidelines that otherwise modify the described methods to meet specific desires of one or more of the parties, the moderator, or another person. In such an embodiment, the predetermined criteria may include any suitable modification to the described methods. Some non-limiting examples of such modifications include statements that the token holder must pass the token within a given amount of time, that the token holder can retain the token indefinitely, that the token can only be passed a limited number of times each day, that the token can be passed any number of times in a specific period, that the token need not be present or on the person of the token holder when the token holder uses it, etc.

Returning back to FIG. 2, at box 106, that figure that as the method 100 continues, the parties are allowed to face a decision conflict (e.g., which movie to watch, where to eat, who gets the front seat in the car, who gets to push the elevator button, etc.). At box 108, FIG. 2 shows that as the described method 100 continues the token holder rightfully has the first option to make the decision that resolves the current conflict. Accordingly, at box 110, FIG. 2 shows the token holder has the choice to use the token and make the decision to resolve the conflict, or to retain the token and allow the other party to make the decision.

If the token holder chooses to not to use the token, box 112 shows that the current token holder retains the token and passes the right to resolve the current conflict to the other party. As a result, box 114 shows the token holder has to acquiesce to the resolution selected by the other party. As a consolation, FIG. 2 shows that by retaining the token, the token holder reserves the right to select the resolution to the next decision conflict, as represented by box 106.

Returning to decision box 110, if the token holder decides to use the token, then box 116 shows the token holder is allowed to make the decision that resolves the conflict (e.g., pick which movie the parties will watch). As a consequence for choosing to resolve the conflict, FIG. 2 at box 118 shows the token holder should pass the token onto the other party.

Box 119 shows the method 100 optionally includes evaluating whether certain predetermined criteria have been met or omitted and then responding to the completion or omission of the criteria. This evaluation and response can occur at any suitable point during the described methods, including, but not limited to, immediately after a party meets a criteria, immediately after a party fails to meet a criteria, after the parties finish using token, or at any other suitable time. According to at least one embodiment, however, box 119 shows the evaluation and response process takes place after the parties have been confronted with a decision conflict and the then current token holder has been allowed to choose whether to make the decision to resolve the conflict and pass the token, or to retain the token and allow the other party to make the decision that resolves the current conflict.

As the method 100 continues, decision box 120 shows that the parties or the moderator may be faced with the decision as to whether to allow the current token holder to resolve the next conflict. If the decision is made to continue and to allow the current token holder to have the option to resolve the next conflict, box 120 of FIG. 2 shows the method 100 is repeated by returning to box 106. In contrast, if the decision is made at box 120 that the current token holder is not allowed to make the next decision, the method may end in any suitable manner. In one non-limiting example, FIG. 2 at 122 shows the method 100 proceeds by requiring the current token holder to give the token to the moderator (e.g., a parent or guardian). Thus, the embodiment illustrated in FIG. 2 ends at 124.

As mentioned above, the described apparatus and methods may be modified in any suitable manner. Indeed, in some embodiments, the methods are modified to allow more than two parties to resolve a decision conflict without intervention from an outside decision maker, such as a moderator.

Where the described methods are used to allow more than two parties to resolve a decision conflict, the methods can be used with any suitable number of parties, including, but not limited to, 3, 4, 5, 6, 7, 8, 9, 10, or more parties.

Where the described methods and apparatus are used with more than two parties, the tokens may have any characteristic that allows the parties to distinguish a hierarchical ranking between the tokens. By way of non-limiting example, the tokens are labeled 1, 2, 3, etc.; the tokens are gold, silver, bronze, etc.; the tokens are long, short, shorter, etc.; the tokens are larger, small, smaller, etc.; or the tokens are distinguishable in any other suitable manner that indicates that the tokens have differing hierarchical rankings.

Where the described methods are modified to allow more than two parties to resolve decision conflicts, the methods can be modified in any suitable manner. In one non-limiting example, all but one of the parties receives a token having a different hierarchical ranking that indicates that the party holding that particular token has an option to resolve a decision conflict before at least one other party to a conflict. In other words, each party in this example (with the exception of one) receives a token that designates the order or rank in which that party has the option to resolve a decision conflict before another part. The party in this example that does not receive a token that has a hierarchical ranking that is higher than the ranking of another token may receive the lowest ranking token (a “slug”) or no token at all. Thus, in some embodiments, this lowest ranked party only has the option to make the decision that resolves a decision conflict after all of the parties having a higher ranking token choose to retain their tokens and to pass the option to make the decision onto another.

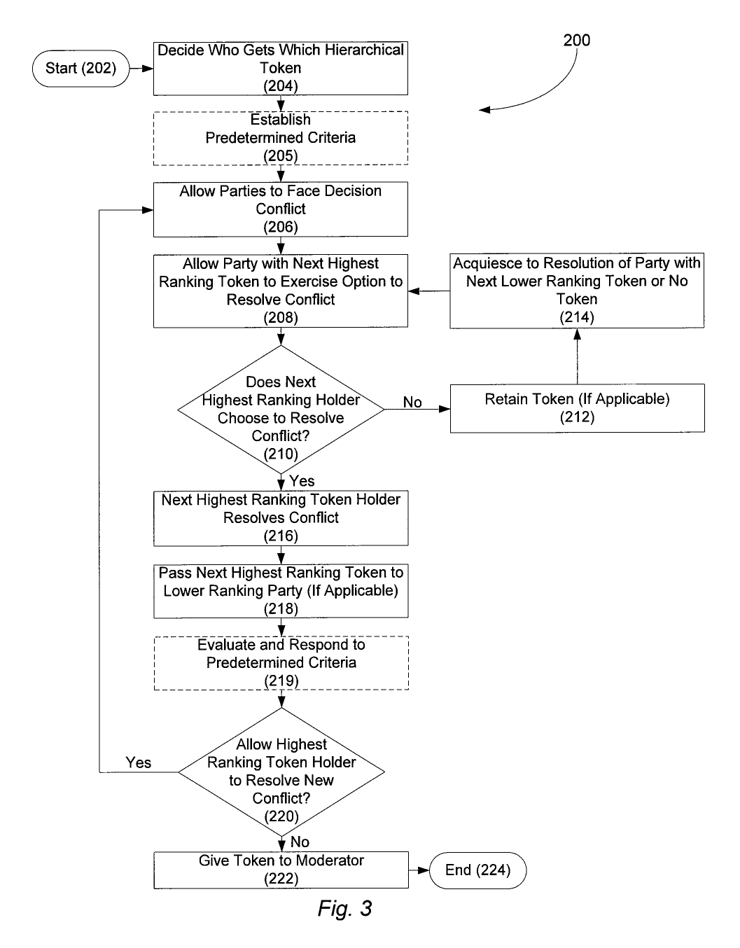

FIG. 3 illustrates a flow chart of a representative embodiment of a method 200 for resolving decision conflicts between more than two parties through the use of hierarchical tokens. While FIG. 3 illustrates one presently preferred embodiment, it should be noted that the method 200 in FIG. 3 can be modified in any suitable manner. For instance, one or more elements can be added to, removed from, or rearranged within the method 200 in any suitable manner that allows more than two parties to use hierarchical tokens to resolve a conflict decision.

With respect to FIG. 3, that figure shows that after beginning at 202, the method 200 proceeds to box 204, in which the decision is made as to how the hierarchical tokens are to be distributed among the parties. This decision as to how the tokens will be distributed among the parties may be made in any suitable manner, including, but not limited to, the drawing of straws, the casting of lots, by picking the tokens out of the proverbial hat, according to the age of the parties, or by any other suitable method.

Box 205 in FIG. 3 shows that the method 200 optionally includes establishing at least one predetermined criterion that modifies the method from its most basic form. As discussed above with respect to the methods for resolving conflicts between two parties (e.g., method 100 illustrated in FIG. 2), the predetermined criteria used in methods for resolving conflicts between more than two parties (e.g., method 200 from FIG. 3) may be established at any suitable time, including, but not limited to, before the parties are faced with a decision conflict. Additionally, as previously discussed, the predetermined criteria may comprise any suitable statements, criteria, rules, or other suitable guidelines that modify and/or further delineate the method 200 while allowing more than two parties to resolve a conflict decision through the use of hierarchical tokens.

As the method 200 continues, box 206 shows the parties are allowed to face a decision conflict (e.g., who will play a single-player game first, who gets to play with a toy, etc.). Next, at box 208, FIG. 3 shows that the party with the next highest ranking token is allowed to exercise the first option to resolve the current conflict. It should be noted that after the tokens are given to the parties and the parties are faced with their first decision conflict while using the coins, the “party with the next highest ranking token” is the party with the highest ranking token. Accordingly, where the party with the next highest ranking token is the party with the highest ranking token, decision box 210 shows that the party with the highest ranking token is faced with the decision to use the token and make the decision to resolve the conflict, or to retain the token and pass the opportunity to make the decision that resolves the conflict onto the party having the second highest ranking token.

At box 212, FIG. 3 shows that if the party with the highest ranking token chooses to pass the decision and retain its token, the method 200 proceeds to box 214 where the party holding the highest ranking token becomes subject to the decision of the party with the second highest ranking token (or to a subsequent party's decision, should the party with the second highest ranking token choose to retain its token and pass the decision on to the next lower ranked party).

Accordingly, box 214 shows that once the party with the highest ranking token chooses to retain its token, the party with the second highest ranking token is allowed to exercise its option to resolve the current decision conflict at box 208. Specifically, box 210 shows that, under these circumstances, the party holding the second highest ranking token becomes the “next highest ranking holder” and is given the opportunity to either make the decision that resolves the current conflict and to pass the second highest ranking token to the subsequent party, or to retain the second highest ranking token and pass the opportunity to resolve the conflict onto the subsequent party (or the party having the next lower ranking token, or no token, if applicable).

If after the party with the highest ranked token passes the option to resolve the current conflict to the party with the second highest ranking token (as discussed above), the party with the second highest ranking token is allowed to choose at box 210 to either retain its token (as shown at box 212), or to make the decision and resolve the conflict (as shown at box 216). In circumstances in which the party with the second highest ranking token chooses to retain its token at box 212, then box 214 shows that this party also chooses to acquiesce to the decision of the next lower ranked party (e.g., the party with the third highest ranking token, or the party with no token, if there are three parties and only two hierarchical tokens), should that lower ranked party choose to make the decision to resolve the conflict.

Thus, box 208 shows that the third party, or the subsequent party to the party who retained the second highest ranking token, is faced with the current decision conflict at box 208 and becomes the “next highest ranking holder.” Thus, at box 210, the next highest ranking token holder (e.g., the party holding the third highest ranking token, or the party with no token at all) is given the opportunity to either make the decision that resolves the current decision conflict and pass the token (if it has one), or to pass the decision and retain the token (if it has one).

If the third party (e.g., the party having the third highest ranking token or no token) chooses to pass the decision, box 212 shows this third party can retain its token. Moreover, box 214 shows that the third party is willing to acquiesce to the desires of another, such as the party that has the next lowest ranking token, or the party that has no token, if such is the case. Accordingly, FIG. 3 shows that after the third party retains its token, the method returns to box 208.

If, by chance, each of the parties having a hierarchical token that indicates the opportunity to resolve the conflict decision before another party chooses to retain its token and pass the opportunity down to the subsequent party until the party with the slug or no token at all becomes the next highest ranking holder, then box 210 shows this last party is given the opportunity to make the decision that resolves the current conflict (at box 216) or to pass the decision and acquiesce to the decision of the party with the highest ranking token (or the moderator, or some other suitable person as established in the predetermined criteria) at 214.

Box 216 shows that once the “next highest ranking holder,” whomever that may finally be, chooses to make the decision that resolves the conflict, that party resolves the conflict.

Box 218 shows that if the next highest ranking holder actually possesses a token having a hierarchical ranking that is higher than that of another player, then the next highest ranking token holder passes its token down to the subsequent lower ranked party. By way of non-limiting example, if the next highest ranking holder who makes the decision that resolves the conflict is the party holding the highest ranking token, then that party passes the highest ranking token to the party having the second highest ranking token. In turn, when the party having the second highest ranking token receives the highest ranking token, that party passes the second highest ranking token onto the subsequent party. For instance, the second highest ranking token may be passed to the party holding the third highest ranking token, or if the subsequent party has the slug token or no token at all, then second highest ranking token will be passed to that party. In some embodiments, if the second highest ranking token is passed to the party with the slug, then the slug is passed to the party who resolved the current conflict decision and who just passed on the highest ranking token. As a side note, in some instances, if the party who receives the second highest ranking token did not have a token, then the party who resolved the decision and passed the highest ranking token on ends up without a token and becomes the lowest ranked party.

Progressing through the method 200, box 219 shows the method 200 optionally comprises one or more processes of evaluating and responding to the completion and/or omission of the predetermined criteria established at box 205. While such a process can be accomplished at any suitable point in the method 200, FIG. 3 shows an embodiment in which the evaluation and response to the completion and/or omission of the predetermined criteria is accomplished after the next highest ranking holder makes the decision that resolves a conflict decision.

Continuing on in the method 200, decision box 220 shows that, in this embodiment, the parties, a moderator, or some other suitable decision maker, is faced with the decision to allow the current party holding the highest ranking token to resolve the next conflict. If the decision is made to continue and to allow the current highest ranking token holder to have the option to resolve the next conflict, FIG. 3 at 220 shows the method 200 is repeated by returning to box 206. In contrast, if the decision is made that the current highest ranking token holder is not allowed to make the next decision, the method 200 may end in any suitable manner. In a non-limiting example, FIG. 3 at 222 shows the method 200 proceeds by requiring the parties to give their tokens to a moderator (e.g., a parent, guardian, teacher, etc). Thus, FIG. 3 shows the method 200 ends at 224.

In addition to the aforementioned benefits and advantages, the described apparatus and methods may offer several additional benefits. In one non-limiting example, the described methods allow multiple parties to resolve conflict on their own, without oversight from a moderator. In this example, not only do the parties learn how to resolve conflict, but the moderator (e.g., parent, guardian, teacher, friends, etc.) will no longer have to mediate the decision conflicts or be held responsible for an “unfair” outcome.

In still another non-limiting example, the described methods teach the art of prioritizing the importance of parties wants and desires. In other words, the described methods can teach the parties of the benefits of deferred gratification as opposed to immediate gratification. Similarly, the described methods can teach the parties how to strategize by prioritizing the importance of each conflict. For instance, repeated implementation of the described methods will teach the parties that another conflict will likely arise in the future, and that, perhaps, the next conflict will be of greater value than the current issue.

In still another non-limiting example, the described methods allow each party to be a winner in every conflict. Indeed, in one embodiment, in every conflict each party will either be able to make the decision to resolve the conflict or have a token that provides them with a first option or a ranking option to decide the next conflict.

The present invention may be embodiment in other specific forms without departing from its spirit or essential characteristics. The described embodiments and examples, are all to be considered in every respect as illustrative only, and not as being restrictive. The scope of the invention is, therefore, indicated by the appended claims rather than by the foregoing description. All changes that come that come within the meaning and range of equivalency of the claims are to be embraced within their scope.

What is claimed is:

1. A method for resolving a decision conflict between two parties, the method comprising:
providing a first party with a token representing a right to resolve the decision conflict;
establishing at least one predetermined criterion for determining a factor selected from whether the decision conflict qualifies for use of the token to resolve the decision conflict, when either of the two parties looses a right to use the token, when either of the two parties qualifies for a positive reinforcement based on behavior associated with use of the token, and how the method should be modified to meet a specific desire;
allowing the two parties to face the decision conflict; and
allowing the first party to choose between a first choice of resolving the decision conflict and passing the token to a second party, and a second choice of retaining the token and acquiescing to a resolution selected by the second party.

2. The method of claim 1, further comprising determining which of the two parties will be the first party provided with the token.

3. The method of claim 1, comprising establishing the at least one predetermined criterion for determining when the either of the two parties looses the right to use the token.

4. The method of claim 1, comprising establishing the at least one predetermined criterion for determining when either of the two parties qualifies for the positive reinforcement based on behavior associated with token use.

5. The method of claim 1, comprising establishing the at least one predetermined criterion for determining whether the decision conflict qualifies for use of the token to resolve the decision conflict.

6. A method for resolving a decision conflict between more than two parties, the method comprising:
providing all but one of the parties with a token having a hierarchical ranking that represents an option to resolve the decision conflict before at least one other party, wherein each of the tokens has a different hierarchical ranking, and wherein the hierarchical ranking of each of the tokens represents an order in which each of the more than two parties has an opportunity to resolve the decision conflict;
allowing the parties to face the decision conflict;
allowing a first party having a first token with a highest hierarchical ranking to choose between a first choice of resolving the decision conflict and passing the first token onto a second party, and a second choice of retaining the first token and allowing the second party possessing a second token that has a second highest hierarchical ranking to choose between a third choice of resolving the decision conflict and passing the second token to a third party, and a fourth choice of retaining the second token and allowing the third party to have a right to resolve the decision conflict.

7. The method of claim 6, wherein when the first party resolves the decision conflict and passes the first token to the second party, the second party passes the second token to the third party.

8. The method of claim 6, further comprising establishing at least one predetermined criterion for determining whether the decision conflict qualifies for use of one of the hierarchical tokens to resolve the decision conflict.

9. The method of claim 6, further comprising establishing at least one predetermined criterion for determining when any of the more than two parties looses a right to use one of the tokens.

10. The method of claim 6, further comprising establishing at least one predetermined criterion for determining when any of the more than two parties qualifies for a positive reinforcement based on behavior associated with token use.

11. The method of claim 6 further comprising establishing at least one predetermined criterion for determining how the method should be modified to meet a specific desire.

12. A method for resolving a decision conflict between more than two parties, the method comprising:
providing one of at least two hierarchical tokens to at least two of the more than two parties, wherein each of the at least two hierarchical tokens has a different hierarchical ranking, and wherein the hierarchical ranking of the at least two hierarchical tokens represents an order in which each of the more than two parties has an opportunity to resolve the decision conflict;
establishing at least one predetermined criterion for determining a factor selected from whether the decision conflict qualifies for using any of the at least two hierarchical tokens to resolve the decision conflict, when any of the more than two parties looses a right to use one of the tokens, and when any of the more than two parties qualifies for a positive reinforcement based on behavior associated with token use;
allowing the parties to face the decision conflict;
allowing a first party having a first token with a highest hierarchical ranking to choose between a first choice of resolving the decision conflict and passing the first token to a second party, and a second choice of retaining the first token and allowing the second party possessing a second token that has a second highest hierarchical ranking to choose between a third choice of resolving the decision conflict and passing the second token to a third party, and a fourth choice of retaining the second token and allowing the third party to have a right to resolve the decision conflict.

13. The method of claim 12, wherein at least one of the at least two hierarchical tokens comprises a coin.

14. The method of claim 12, wherein when the first party having the first token chooses the first choice and passes the first token to the second party, the second party passes the second token to the third party.

15. The method of claim 12, wherein at least one of the at least two hierarchical tokens comprises instructions indicating how to resolve the decision conflicts through token use.

16. The method of claim 12, further comprising determining which of the more than two parties will be the first party provided with the first token.

17. The method of claim 12, comprising establishing the at least one criterion for determining whether the decision conflict qualifies for using any of the at least two hierarchical tokens to resolve the decision conflict.

18. The method of claim 12, comprising establishing the at least one predetermined criterion for determining when any of the more than two parties looses a right to use one of the tokens.

19. The method of claim 12, comprising establishing the at least one criterion for determining when any of the more than two parties qualifies for the positive reinforcement based on behavior associated with token use.

20. The method of claim 12, wherein the providing the one of the least two hierarchical tokens to the at least two of the parties comprises providing a lowest ranked party with a slug.
